(19) United States
(12) Patent Application Publication
(10) Pub. No.: US 2014/0216127 A1
(43) Pub. Date: Aug. 7, 2014

(54) SEPARATED TYPE PRESSURE GAUGE

(71) Applicants: PURERON JAPAN CO., LTD., Fukushima (JP); MD INNOVATIONS CO., LTD., Tokyo (JP)

(72) Inventors: Mitsuteru Kimura, Miyagi (JP); Seiji Ishihara, Tokyo (JP)

(73) Assignees: MD Innovations Co., Ltd, Tokyo (JP); Purreon Japan Co., Ltd, Fukushima (JP)

(21) Appl. No.: 14/130,196

(22) PCT Filed: Jun. 25, 2012
(86) PCT No.: PCT/JP2012/066159

§ 371 Date: Mar. 26, 2014

(30) Foreign Application Priority Data
Jun. 30, 2011 (JP) 2011-145495

(51) Int. Cl. G01L 27/00

(52) U.S. Cl. CPC G01L 27/002
USPC 73/1.57

(57) ABSTRACT

In order to basically solve the problem of the change with time of a standard barometric pressure including a vacuum in a standard pressure chamber of a separated type pressure gauge, provided is a separated type pressure gauge in which even if the atmospheric pressure in a standard pressure chamber of the separated type pressure gauge fluctuates due to, for example, the change with the passage of time, a standard barometric pressure in the standard pressure chamber is measured and can be calibrated. In the separated type pressure gauge having a standard pressure chamber, a heat conduction type barometric sensor is equipped in the standard pressure chamber, and the atmospheric pressure in the standard pressure chamber is measured constantly or as necessary to use the measured atmospheric pressure as a standard barometric pressure. The heat conduction type sensor uses a silicon substrate and includes an absolute temperature sensor.

### TECHNICAL FIELD

The present invention relates to a separated type pressure gauge for measuring a barometric pressure, the term referred to herein used to include an air, a gas and a vacuum pressure, the separated type pressure gauge having a standard pressure chamber that is equipped with a barometric sensor for measuring a barometric pressure that may have been changed from a preset standard (reference) barometric pressure in the standard pressure chamber, so as to allow sensing such a change of standard barometric pressure, e.g. with the passage of time, whereby the measured barometric pressure can be utilized as a modified standard barometric pressure.

### BACKGROUND ART

A separated type pressure gauge has hitherto been used to measure absolute pressures in a region of vacuum and a also not less than 1 atmospheric pressure. The separated type pressure gauge is provided with a measuring barometric chamber (measuring chamber) for measuring a barometric pressure to be measured and additionally with a reference or standard pressure chamber separated by a diaphragm from the measuring chamber. In measuring a barometric pressure to be measured, reference is taken of an absolute barometric pressure including a vacuum pressure in the standard pressure chamber, the pressure set at the time of manufacture of the separated type pressure gauge. And a displacement of the diaphragm deformed by a pressure difference between the absolute barometric pressure in the standard pressure chamber and an absolute barometric pressure in the measuring chamber is measured from a change of electrostatic capacitance or a change in output of a strain gauge. To wit, a barometric pressure as measured is calibrated with an absolute barometric pressure in the standard pressure chamber taken as a reference of measurement.

A separated type pressure gauge needs to be able to measure pressure of a gas regardless of its type. For use, e.g. in a reaction chamber for a plasma CVD apparatus where there may develop a variety of etching and unstable gases, it is required that the barometric pressure gauge can be composed of a corrosion resistant material, e.g. stainless steel, tantalum or Teflon™, which is resistant to corrosive gases such as hydrogen chloride and ammonium in particular, and that it can have its inside resistant to a high temperature while preventing a gas from attaching to its inner walls or elements. From such necessities, in such a reaction chamber there has often be required and used a separated type pressure gauge and especially a diaphragm type vacuum pressure gauge. Further, a method to measure a relative pressure not less than 1 atmospheric pressure has been carried out in which the standard pressure chamber is open to an atmosphere, and the atmospheric pressure made in the standard barometric chamber is taken as a standard barometric pressure. A barometric pressure in the measuring chamber (a pressure to be measured) is measured from a displacement of the diaphragm deformed by a pressure difference between the pressure in the measuring chamber and the atmospheric, standard pressure in the standard pressure chamber.

Separated type pressure gauges to measure a displacement of the diaphragm can largely be classified into those of type of electrostatic capacitance and type of strain gauge. A separated type pressure gauge of electrostatic capacitance type comprises a pair of electrodes of which one is constituted by the diaphragm and the other is disposed at one or each of both sides of the diaphragm to form a region of electrostatic capacitance across the electrodes. A displacement of the diaphragm is measured from a change of electrostatic capacitance of the region of electrostatic capacitance. In a separated type pressure gauge of strain gauge type, the diaphragm has been formed with a strain gauge a change of whose resistance value is sensed to detect a displacement of the diaphragm. An amount of detected displacement of the diaphragm is utilized to determine an absolute pressure in the measuring chamber. Greater use is made of the capacitance type which is less in temperature dependency. Increasing its sensitivity, however, requires increasing the electrostatic capacitance to sense displacements of the diaphragm, which in turn requires the diaphragm acting as one electrode necessarily to be increased in diameter and to be larger in size.

In a separated type pressure gauge, however, there has arisen a problem that set at the time of its manufacture, a barometric pressure, including a vacuum pressure, in the standard pressure chamber may undergo a change with the passage of time, caused by outgassing from the standard pressure chamber, a vacuum or gaseous barometric measurement error in the standard pressure chamber due to its deformation by thermal expansion and a small leak with the standard pressure chamber.

Also, a diaphragm material of which frequent use is made of Inconel may structurally undergo a variation in composition after a change between vacuum and atmosphere is repeated, giving rise to a problem that the zero point may often be drifted.

Further, to better the measurement accuracy requires the diaphragm to be held at a constant temperature. Rise in temperature may expand metal volume and deform the diaphragm if slightly. This requires a measuring member or gauge head as a whole to be received in a thermostat, it taking time until a stabilized temperature is reached. Problems have been further entailed that the measuring part is becoming much larger in size and costly.

Also, with a separated type pressure gauge in which an atmospheric pressure that may vary is taken as a reference of measurement and which is thus used in the recognition that it cannot measure an absolute pressure at precision, there have hitherto been demands to so measure an absolute pressure on the basis of such a variable atmospheric pressure reference.

Measuring a barometric pressure in the standard pressure chamber demands that the standard pressure chamber should include a barometric pressure sensor for measuring that which is an absolute barometric pressure, the barometric pressure sensor being sufficiently smaller in size than the standard pressure chamber. A semiconductor pressure sensor of strain gauge well used, which can be an ultra-small sensor but requires a reference (standard) pressure likewise here, cannot be used to this end. An absolute pressure sensor of ultra-small size has thus been sought which is based on some other detection principle.

A barometric pressure sensor that may be used as a heat conduction type sensor has been invented by one of the present inventors (Patent Reference 1). The barometric pressure sensor uses a SOI substrate of silicon of which a SOI layer is used as a sensing cantilever on which in makeup are disposed one micro-heater (heater) and a pair of thermocouple hot junctions with a region of thermal resistance between the two junctions. The barometric sensor can be made in the form of a sensor chip of 1 mm to several mm. The heater formed on the sensing cantilever is disposed closer to a side of substrate that supports the sensing cantilever than the two thermo-couple hot junctions so that heat may flow from the heater towards the end of the sensing cantilever while radiating into an ambient gas. By measuring a difference in temperature between the two thermocouple hot junctions formed across the region of heat resistance and applying a zero method to the measurement, a vacuum or a high vacuum barometric pressure of the order of 10⁻³ Pa can be measured. Further, for a barometric pressure in a region of low vacuum closer to 1 atmospheric pressure, or not less than 1 atmospheric pressure, thermal expansion of the sensing cantilever is utilized. so that it may deform like a bimetal, Forced cooling by its deformation vibration as then caused is utilized. Thus, measurement of a difference in temperature between the two thermocouple hot junctions allows measuring a barometric pressure, which is in a wide band of a number of eight or more figures, with the single barometric sensor. Accordingly, it may be seen that this barometric sensor is ultra-small in size and can constitute a heat conduction type sensor, the sensor having an absolute temperature sensor also mounted thereon. With a measurable gas identified of its type and with the ability to measure an ambient temperature, the sensor capable of measuring a barometric pressure in a wide range from vacuum to an atmospheric pressure or more thus allows such a barometric pressure inside of a vacuum chamber or a high pressure chamber as small as 1 cm³ in size to be quickly measured.

### PRIOR ART REFERENCE

### Patent Reference

Patent Reference 1: JP 2011. 69733: A

### SUMMARY OF THE INVENTION

### Problems to be Solved by the Invention

In order to fundamentally solve the problem of a conventional separated type pressure gauge that in a standard pressure chamber a standard barometric pressure including a vacuum is varied with the passage of time, it is an object of the present invention to provide a separated type pressure gauge in which if there is a change of barometric pressure in a standard pressure chamber, e.g. by a change thereof with time, a barometric pressure (standard pressure) changed into in the standard pressure chamber can be measured, thereby correcting the barometric pressure changed from in the standard pressure chamber.

### Means for Solving the Problems

In order to achieve the object mentioned above, there is provided in accordance with the present invention in an aspect thereof as set forth in claim 1 of the claims appended hereto a separated type pressure gauge having a standard pressure chamber, characterized in that it includes a thermal pressure sensor equipped inside of the said standard pressure chamber for measuring a barometric pressure in the standard pressure chamber, whereby the measured barometric pressure in the standard pressure chamber is utilized as a standard barometric pressure.

In a separated type pressure gauge, especially in a diaphragm type vacuum pressure gauge, the higher a vacuum to be measured, the more will the precision of measurement be affected by deformation of a diaphragm such as by heat and very little outgassing in a standard pressure chamber and, eventually by changes of these with the passage of time from them at a time of manufacture of the pressure gauge. There have been desires to know a true absolute pressure (a degree of vacuum) or alternatively demands to measure a standard (reference) pressure, inside of the standard pressure chamber at a time of measurement. Further, the higher vacuum, the thinner the diaphragm need be in thickness. Also, since the difference in pressure between the standard and measuring chambers is very small, the diaphragm has needed to he larger in diameter to make its deformation larger in amount.

To measure an absolute barometric pressure in the standard pressure chamber, a barometric pressure sensor is here advantageously used of which a principle of measurement differs from those of the conventional separated type pressure gauges and which moreover is ultra-small in size. A separated type pressure gauge according to the present invention is equipped inside of the standard pressure chamber with a heat conduction type sensor, preferably in the form of a sensor chip as small as 1 mm square or so, to measure an absolute barometric pressure in the standard pressure chamber. And, the measured barometric pressure is utilized as a modified standard barometric pressure which is used to calibrate a barometric pressure in a measuring chamber that communicates with a chamber for collecting a barometric medium whose actual pressure is to be measured.

Thus, in contrast to a conventional separated type pressure gauge which reposes absolute confidence in a standard pressure chamber on an absolute barometric pressure (including a vacuum pressure) which is set at the time of manufacture of the pressure gauge but which may actually change with the passage of time, a separated type pressure gauge according to the present invention is provided in which the absolute pressure in the standard pressure chamber can constantly or instantaneously be monitored and measured. At the time a barometric pressure is to be measured in a measuring chamber, the measured absolute barometric pressure in the standard pressure chamber is taken as a standard barometric pressure. The barometric pressure in the measuring chamber can thus be measured at precision. In passing, note that it remains that an amount of deformation of the diaphragm effected by a difference in pressure between the standard and measuring chambers can be measured through an electrostatic capacitance and a strain gauge. An absolute pressure in the standard pressure chamber should be around a center of a desired range of barometric measures. In general, it is observed that such a range of barometric measures around whose center an absolute temperature in the standard pressure chamber can be measured is of a number of three figures.

The present invention in a specific aspect thereof as set forth in claim 2 of the appended claims provides a separated type pressure gauge in which the standard pressure chamber is a hermetically sealed barometric pressure chamber.

In a separated type pressure gauge when used as a vacuum pressure gauge, a standard pressure chamber when to be made at a selected vacuum is expedited of its spontaneous outgassing in general by first evacuating it forcibly to high vacuum for many days through a heated pipe (connecting pipe) connected to an evacuating or vacuum pump thereof in the gauge. Whereafter the standard pressure chamber is loaded with a gas until a selected pressure is reached therein and it is then sealed upon welding the connecting pipe. The standard pressure chamber is sealed by welding the connecting pipe in this way, or is made at a selected pressure further through a precision valve and hermetically sealed upon closing the valve.

The present invention in a specific aspect thereof as set forth in claim 3 of the appended claims provides a separated type pressure gauge in which the standard pressure chamber is a hermetically sealed pressure chamber in which the barometric pressure is made adjustable in the vicinity of a desired barometric pressure.

The separated type pressure gauge has as range of barometric pressure measures of a number of no more than 3 figures and requires an absolute pressure in the standard pressure chamber to be around a center of such a range as desired. Such an absolute pressure (including a vacuum) in the standard pressure chamber may, when it is changed with time or the like, be deviated as much as by a number of one figure from a desired barometric pressure. In such a case, and in case it is, for example, completely in hermetic seal by wending, a getter material can be included in the standard pressure chamber so as to be activated such as by heating so that a barometric pressure may be returned to lie in the selected range. The barometric pressure in the standard pressure chamber can in such a manner be adjusted in the vicinity of a desired barometric pressure.

The barometric pressure in the standard pressure chamber can also be adjusted in the vicinity of a desired barometric pressure in the use of an ultra-precision needle valve or further on combining the needle valve with a sealing material. Evacuating then the inside of the standard chamber from the outside allows the chamber inside pressure to be returned to the selected barometric pressure range. Of course, when the barometric pressure in the standard pressure chamber is further varied, it can again he adjusted to lie in the selected pressure range.

The present invention in a specific aspect thereof as set forth in claim 4 of the appended claims provides a separated type pressure gauge in which the standard pressure chamber is an air pressure chamber that is open to all atmosphere.

The pressure chamber may be opened to an atmosphere to utilize the atmospheric pressure as a standard pressure. Where a difference from the atmospheric pressure is sought to be zero, the atmospheric pressure need not be measured. There is, however, the case that a change of the atmospheric pressure gives rise to the problem that it needs to be accurately measured. A barometric pressure in the standard pressure sensor that is opened to the atmosphere can then be measured by a beat conduction type sensor to use the measured barometric pressure as a standard pressure.

The present invention in a specific aspect thereof as set forth in claim 5 of the appended claims provides a separated type pressure gauge in which the heat conduction type sensor is used of a silicon substrate.

A heat conduction type sensor as a MEMS which uses a semiconductor silicon substrate, especially a single crystal or a SOI substrate can be a broadband pressure sensor that is of high precision and ultra-small in size and can advantageously be used.

The present invention in a specific aspect thereof as set forth in claim 6 of the appended claims provides a separated type pressure gauge in which the heat conduction type sensor has a sensing cantilever formed with at least one heater and a pair of thermo couples so that measuring a difference between outputs of the said thermo couples allows a barometric pressure to be measured in the said standard pressure chamber.

A pressure sensor as described in the Patent Reference 1 mentioned above is a heat conduction type sensor having a cantilever formed with at least one heater and a pair of therm couples such that a difference in output between the two thermo couples can be measured to measure a barometric pressure. One such pressure sensor which is presently allowed to have a range of pressure measures of a number of eight figures between 1×100⁻³Pa and 3×10⁶ Pa can advantageously be used for a desired range of barometric pressures in a standard pressure sensor in a separated type pressure gauge of the present invention.

The present invention in a specific aspect thereof as set forth in claim 7 of the appended claims provides a separated type pressure gauge in which the heat conduction type sensor is provided with an absolute temperature sensor.

An absolute temperature sensor can he utilized of such as a heat sensitive resistor or thermistor comprising a p-n junction diode, a Schottky barrier diode or a thin film of platinum.

A heat conduction type sensor utilizes the heat radiation effect of a gas by its heat conductivity which in general varies with its type and temperature. Since the type of a gas introduced into the standard pressure chamber is known, if a temperature of the gas, i.e. absolute temperature of the standard pressure chamber in the separated type pressure gauge is identified, an absolute barometric pressure in the standard pressure chamber can univocally be determined on temperature calibration by the heat conduction type sensor. It follows, therefore, that if an absolute temperature is measured by the absolute temperature sensor as mounted to a substrate (e.g. silicon substrate) of the heat conduction type sensor in good thermal contact with a wall of the standard pressure chamber, an absolute pressure in the standard pressure chamber can be computed accordingly.

The present invention in a specific aspect thereof as set forth in claim 8 of the appended claims provides a separated type pressure gauge in which the heat conduction type sensor is constituted of a sensor chip incorporating an integrated circuit having an amplifier circuit.

The sensor chip of the heat conduction type sensor is used preferably of a SOI substrate in particular to form the sensing cantilever with a thin film of thermo couple. Using a silicon substrate facilitates loading the same substrate with a computing circuit including an amplifier and a memory circuit and, further with a heater driver circuit. Also, the sensor chip of the heat conduction type sensor can also be loaded with a temperature sensor for sensing a temperature of a gas and a sensor for sensing a heat conductivity of the gas to allow detecting its type as well, and converting them into a barometric pressure, and permitting these sensors to be incorporated into a single pressure sensing system.

The present invention in a specific aspect thereof as set forth in claim 9 of the appended claims provides a separated type pressure gauge which is modularized having the heat conduction type sensor for a barometric sensing function and having at least an amplifier circuit, a computing circuit and a heater drive circuit which are further included therein.

In a separated type pressure gauge according to the present invention, a sensor chip of a heat conduction type sensor equipped inside of a standard pressure chamber may incorporate measuring circuit portions such as an amplifier circuit, a computing circuit and a heater drive circuit of the sensor each in the form of an integrated circuit in the sensor chip. Alternatively, they may be disposed outside of the standard pressure chamber and configured to exchange electrical signals with the sensor chip of the heat conduction type sensor via external terminals mounted to a wall of the standard pressure chamber as hermetically sealed. The separated type pressure gauge may be modularized having also a function to raise the temperature to, and maintain it at a selected level, a variety of control circuits, given output terminals and a display.

### EFFECTS OF THE INVENTION

In accordance with the present invention a separated type pressure gauge is advantageously provided which is equipped in a standard pressure chamber with a pressure sensor constituted by a heat conduction type sensor, and which if a standard (reference) barometric pressure in the standard pressure chamber has changed, is capable of measuring a change of the reference barometric pressure. In the standard pressure chamber, therefore, a measured reference barometric pressure changed into at a time of measurement of a barometric pressure in a measuring chamber can advantageously be used to measure the barometric pressure in the measuring chamber at high precision.

In accordance with the present invention a separated type pressure gauge is advantageously provided in which a barometric pressure including a vacuum pressure in the standard pressure chamber can be adjusted at a desired barometric pressure, by using a high precision needle valve or by combining it with a sealing material.

In accordance with the present invention a separated type pressure gauge is advantageously provided in which the ability to adjust a barometric pressure including a vacuum pressure in the standard pressure chamber at a desired barometric pressure makes it unnecessary to evacuate, while heating, the inside of the standard pressure chamber for many days as in the prior art until an outgas of the standard pressure chamber is depleted.

In accordance with the present invention a separated type pressure gauge is advantageously provided in which the standard pressure chamber can be opened to an atmosphere. The possibility for the atmosphere to be measured of its absolute pressure allows a conventional relative pressure sensor to be advantageously used as an absolute pressure sensor as well.

In accordance with the present invention a separated type pressure gauge is advantageously provided in which the use of a silicon substrate in a barometric pressure sensor chip allows the same substrate to be loaded with an integrated circuit for each of such circuits as for amplifying, computing and controlling sensor outputs and makes the barometric pressure sensor compact.

In accordance with the present invention a separated type pressure gauge is advantageously provided in which a heat conduction type sensor equipped with an absolute temperature sensor allows an absolute barometric pressure in a standard pressure chamber, as a type of gas introduced into the standard pressure chamber for pressure adjustment is known, and if the absolute temperature is identified by the absolute temperature sensor, to be measured from an output of the heat conduction type sensor, then permitting the measured absolute barometric pressure to be used as a standard pressure in the standard pressure chamber.

In accordance with the present invention a separated type pressure gauge is advantageously provided in which a heat conduction type sensor is included in the form of a sensor chip that can easily incorporate integrated circuits and which accordingly is compact and low in cost.

In accordance with the present invention a separated type pressure gauge is advantageously provided in which a barometric pressure in a standard pressure chamber can constantly or where necessary be measured, which is modularized having a variety of functions such as of a driver and a control circuit and which accordingly is compact and high in reliability.

### BRIEF DESCRIPTION OF THE DRAWINGS

In the Drawings:

FIG. 1 is a conceptual view diagrammatically illustrating one embodiment of the separated type pressure gauge measuring part of a separated type pressure gauge according to the present invention (Form of Implementation 1);

FIG. 2 is a plan view diagrammatically illustrating one embodiment of the sensor chip (heat conduction type sensor chip) of a heat conduction type sensor attached to a standard pressure chamber in a separated type pressure gauge of the present invention (Form of Implementation 1);

FIG. 3 is a conceptual view diagrammatically illustrating another embodiment of the separated type pressure gauge measuring part of a separated type pressure gauge according to the present invention in which the standard. pressure chamber is opened to, and in communication with, an atmosphere (Form of Implementation 2);

FIG. 4 is a plan view diagrammatically illustrating another embodiment of the heat conduction type sensor chip of a heat conduction type sensor attached to a standard pressure chamber in a separated type pressure gauge of the present invention in which the heat. conduction type sensor chip incorporates integrated circuits (Form of implementation 3); and

FIG. 5 is a conceptual view diagrammatically illustrating one embodiment of a modularized separated type pressure gauge according to the present invention (Form of Implementation 4).

### DESCRIPTION OF REFERENCE CHARACTERS

1 heat conduction type sensor chip
2 substrate
10 heat conduction type sensor
11 gauge housing for separated type pressure gauge
12 hermetic seal
15 diaphragm
16 standard pressure chamber
17 measuring chamber
18 measurement chamber communicating section.
19 capacitance measuring electrode
20 region of electrostatic capacitance
21 absolute temperature sensor
22 ohmic contact
25 heater
28 strain gauge
30 gauge head connecting pipe
31 vacuum & evacuation sealing pipe
32 sealing member
40 cavity
41 area of thermal resistance
45 sensing cantilever
46 cantilever end region
50 silicon oxide film
71a, 71b thermocouple electrode pad.
72a, 72b heater electrode pad
73a, 73b absolute temperature sensing electrode pad
81a, 81b thermoelectric couple hot junction
82 thermoelectric couple cold junction
100 separated type pressure gauge head
110 capacitance measuring electrode terminal
111 strain gauge measuring terminal.
115 heat conduction type sensor terminal
120a, 120b thermoelectric couple.
130 atmospheric pressure communicating pipe
210 wiring
250 diaphragm support ring
300 integrated circuit
301 amplifier circuit.
302 computing circuit
303 heater driver circuit
304 displaying circuit
305 distributor
310 integrated circuit electrode pad
400 circuit module
410 printed circuit board
420 socket terminal block or board
430 terminals
450 display
500 modularized separated type pressure gauge

### MODES FOR CARRYING OUT THE INVENTION

In accordance with the present invention there is provided a separated type pressure gauge comprising a heat conduction type sensor which is included inside of a standard pressure chamber and which can he formed on a silicon (Si) substrate and in particular on SOI (silicon on insulator) substrate formable thereon with an IC, readily by the use of semiconductor integration techniques and MEMS (Micro Electro Mechanical System) technologies. The separated type pressure gauge having this heat conduction type sensor loaded therein to measure a barometric pressure in the standard pressure chamber and to utilize the measured. barometric pressure as a standard barometric pressure is described in detail below with respect to forms of implementation thereof with reference to the Drawing Figures.

### Form of Implementation 1

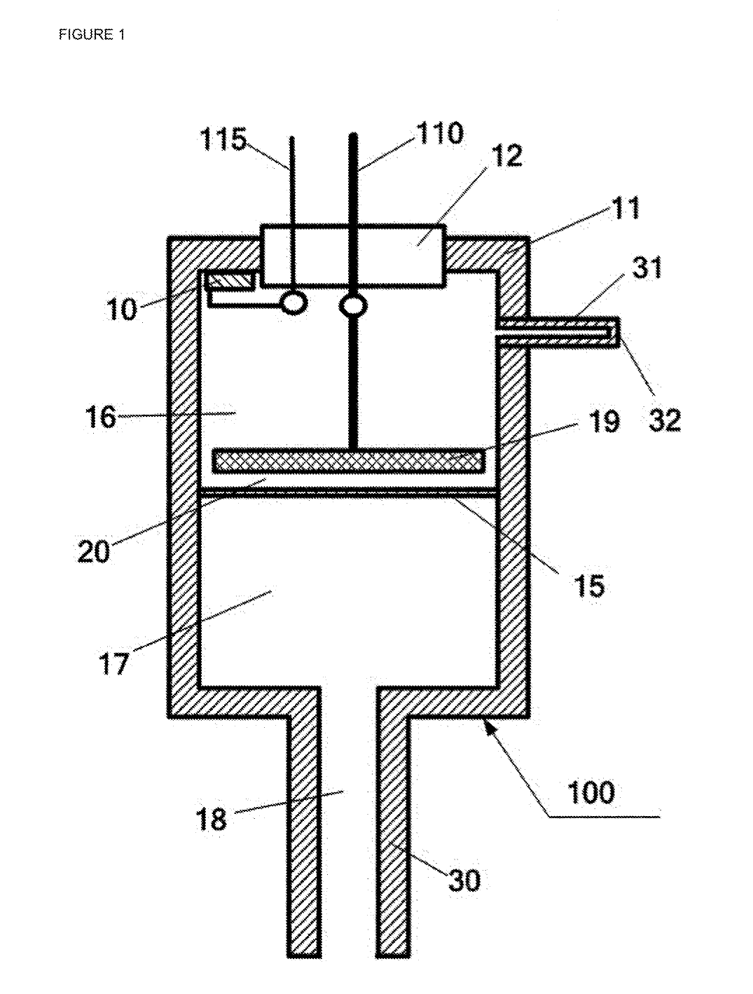

FIG. 1 is a conceptual diagrammatic view illustrating one embodiment of separated type pressure gauge head 100 in a separated type pressure gauge according to the present invention. Mention is made of a capacitance type separated type pressure gauge in this form of implementation that utilizes a change in electrostatic capacitance in measuring a displacement of a diaphragm in separated type pressure gauge which is deformed by a barometric pressure in a measuring chamber 17 exposed to an air or any other gaseous medium (including a vacuum) of which a pressure is to be measured.

The capacitance type separated type pressure gauge generally as shown in FIG. 1 has a diaphragm 15 mounted inside of the separated type pressure gauge head 100 and is divided into the measuring chamber 17 exposed to air or any other gaseous medium (including a vacuum) of which a pressure is to be measured and a standard pressure chamber 16 having a barometric pressure preset to constitute a pre-determined reference value. If the barometric pressure to be measured of the measuring chamber 17 becomes, e.g. greater, than the barometric pressure of the standard pressure chamber 16 by a pressure difference ΔP, then the diaphragm 15 is bent and deformed towards the standard pressure chamber 16 by the pressure difference ΔP. That ΔP=0 leaves the diaphragm 15 not deformed in a separated type pressure gauge in general and makes the electrostatic capacitance C equal to a predetermined capacitance C₀ in the capacitance type separated type pressure gauge. The capacitance type separated type pressure gauge has its electrostatic capacitance C measured in a region of electrostatic capacitance 20 of the separated type pressure gauge head 100 between one electrode constituted by the diaphragm 15 composed of an electrical conductor and the other electrode that is a capacitance measuring electrode 19. When the pressure difference AP is positive as mentioned above, the spacing between the diaphragm 15 and the capacitance measuring electrode 19 is reduced, varying the electrostatic capacitance C to increase. In this manner, a variation ΔC of electrostatic capacitance C which corresponds to a pressure difference ΔP is utilized to find a difference from the standard (reference) barometric pressure proper, thereby measuring the barometric pressure in the measuring chamber 17, i.e. the barometric pressure to be measured. Where a barometric pressure to be measured is measured in this way, change of the standard barometric pressure with the passage of time has been a most anxious factor of the separated type pressure gauge.

As shown in FIG. 1, the separated type pressure gauge head 100 of the capacitance type separated type pressure gauge includes a separated type pressure gauge housing 11 composed of metal in which the standard pressure chamber 16 and the measuring chamber 17 are defined by the diaphragm 15. A heat conduction type sensor 10 is mounted in the standard pressure clamber 16 and attached to the separated type pressure gauge housing 11 in sufficient thermal contact therewith. Power is supplied to and signals are exchanged with the heat conduction type sensor 10 by wiring, e.g. through a hermetic seal 12 having a terminal which electrically conducts between a vacuum area and an environment of atmospheric pressure, i.e. a heat conduction type sensor terminal 115 as an external terminal of the separated type-pressure gauge head 100. Also, a signal for the region of electrostatic capacitance 20 defined between the capacitance measuring electrode 19 and the diaphragm electrode 15 is conducted in this form of implementation through the separated type pressure gauge housing 11 and the diaphragm 15 to measure an electrostatic capacitance between the separated type pressure gauge housing 11 and the capacitance measuring electrode 19. Further, it is made possible for an electric potential of the capacitance in electrode 19 to be measured through a capacitance measuring electrode terminal 110 passing through the hermetic seal 12.

The standard pressure chamber 16 in the separated type pressure gauge head 100 of the capacitance type separated type pressure gauge as shown in FIG. 1 is evacuated to a vacuum through a vacuum and evacuation sealing pipe 31 and thereafter is loaded with a known inert gas such as nitrogen gas until a selected stable standard barometric pressure level is reached. At this point of time the vacuum and evacuation sealing pipe 31 is sealed by a sealing member 32.

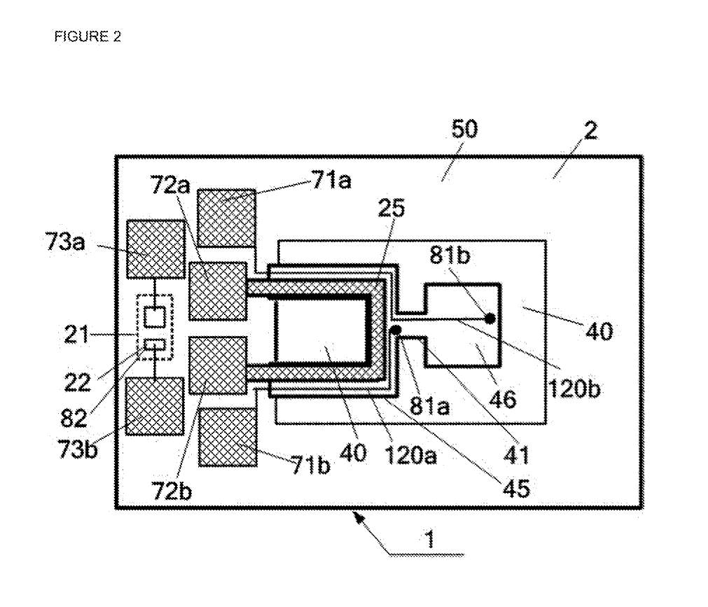

FIG. 2 is a diagrammatic plan view illustrating a heat conduction type sensor chip 1 that constitutes the heat conduction type sensor 10 attached in the standard pressure chamber 16 to the separated type pressure gauge housing 11 of the separated type pressure gauge head 100 shown in FIG. 1. In this form of implementation, a substrate 2 is used of silicon single crystal which in particular is a SOI (silicon on insulator) substrate, and a sensing cantilever 45 is formed utilizing such a SOI layer. The cantilever 45 thermally isolated. from the substrate 2 is provided, with a heater 25 made of, e.g. a thin nichrome film, on a silicon oxide film 50 formed on a surface of the SOI layer. Towards an end of the cantilever 45 there are formed across an area of heat resistance 41 a pair of thermocouple hot junctions 81a and 81b of a pair of thermo (thermoelectric) couples 120a and 120b. The two thermo couples 120a and 120b on the one hand are each formed of a first thermocouple material i.e. a thin metal film (e.g. thin nichrome film) formed on the silicon oxide film 50 on the surface of the SOT layer, the thermo couples 120a and 120b ending with the thermocouple hot junctions 81a and 81b, respectively. Formed each of the one thermocouple material. on the one hand, the thermo couples 120a and 120b on the other hand are each formed of a second thermocouple material used of the SOI layer of n-type semiconductor, the thermo-couples 120a and 120b ending with a common thermocouple cold junction 82. Having one terminal also in common to the thermocouples 120a and 120b, an absolute temperature sensor 21 is formed on the substrate 2. Thermocouple electrode pads 71a and 71b and absolute temperature sensor electrode pads 73a and 73b are, also arranged and formed on the substrate 2 so that a thermoelectromotive force of one of the two thermo couples 120a and 120b indicated between the thermocouple electrode pads 71a and 71b can, where necessary, be taken out of the absolute temperature sensor electrode pad 73b leading from the one of terminals of the absolute temperature sensor 21. As a matter of course, a difference in thermoelectromotive force between the two thermo couples 120a and 120b, i.e. a difference in temperature between the two thermocouple hot Junctions 81a and 81b can be taken out of between the thermoelectric electrode pads 71a and 71b, in this form of implementation, it is noted further that the absolute temperature sensor 21 may be used of a p-n junction diode that can be formed with ease. Since a heat conduction type sensor chip that can be used in the present invention can be made readily using a known technique of manufacturing an EMS semiconductor device, a description of its process of manufacture is omitted herein.

With respect to a difference in temperature between the thermocouple hot junctions 81a and 81b, heat from the heater 25 flows through the sensing cantilever 45 towards the thermocouple hot junctions 81a and 81b. When the environment becomes vacuum to a high degree, the heat from the heater 25 does not thermally conduct into the environment so that its radiation can be disregarded. The difference in temperature between the thermocouple hot junctions 81a and 81b across the area of heat resistance 41 will then essentially become zero. At the high vacuum the differential output voltage between the thermocouple electrode pads 71a and 71b then becoming essentially zero, the zero can constitute a reference of measurement. Where a zero method is applicable a barometric pressure such as of a vacuum can he measured at an extremely high precision.

### Form of Implementation 2

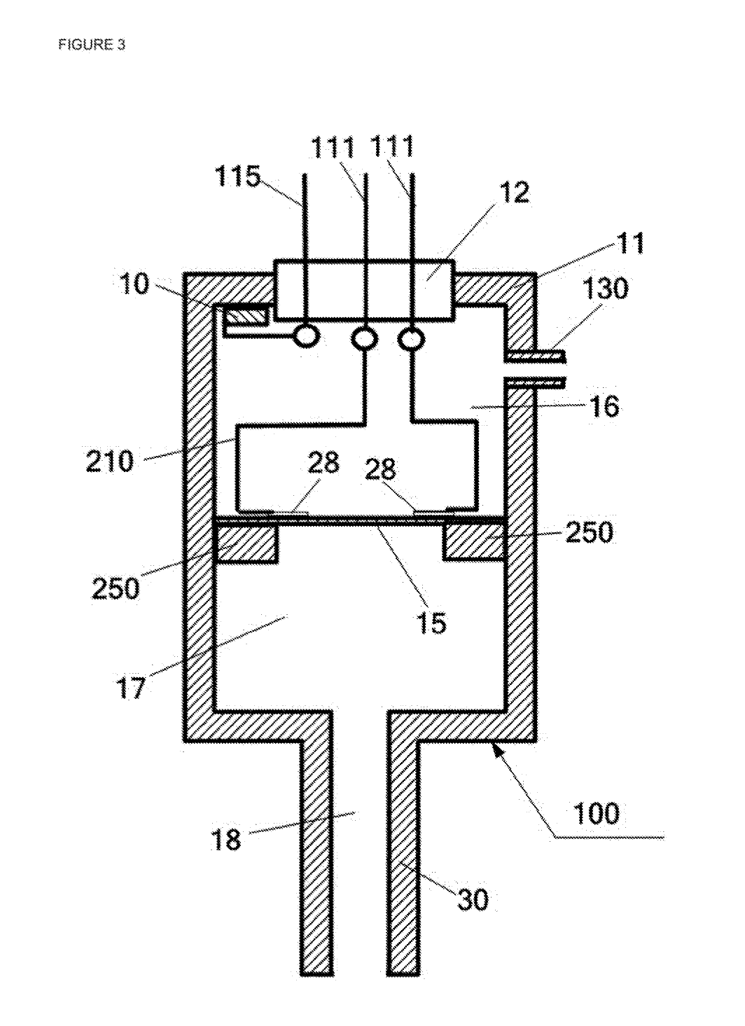

FIG. 3 is a conceptual diagrammatic view illustrating an embodiment of separated type pressure gauge head in a separated type pressure gauge of the present invention in which a standard pressure chamber is in communication with an atmosphere. While in the Form of Implementation 1 shown in FIG. 2 a displacement of the diaphragm 15 responsive to a pressure difference AP in barometric pressure between the measuring member 17 and the standard pressure chamber 16 is measured as a change in electrostatic capacitance, in this form of implementation shown in FIG. 3 a displacement of the diaphragm 15 is measured from a resistance change of a strain gauge 28 formed on the diaphragm 15. A plurality of such strain gauges 28 are used to constitute arms of a Wheatstone bridge so as to allow measuring a resistance change of the Wheatstone bridge at precision so that a pressure difference ΔP can in result be measured at high precision, it follows, therefore, that a barometric pressure is measured in the measuring chamber 17 by including a pressure difference ΔP thus measured at high precision with reference to an atmospheric pressure in the standard pressure chamber 16. In this form of implementation, measuring an atmospheric pressure in the standard pressure chamber 16 at high precision a heat conduction type sensor 10 provided in the standard pressure chamber 16 makes it possible to measure a barometric pressure in the measuring chamber 17 at high precision as well. Parenthetically, current is supplied to the strain gauges 28 and signals are exchanged between the strain gauges 28 and the outside via gauge terminals 111 passing through the hermetic seal 12. Other operational aspects of the present invention are identical here to those of the Form of Implementation 1 mentioned above and a description thereof is omitted.

### Form of Implementation 3

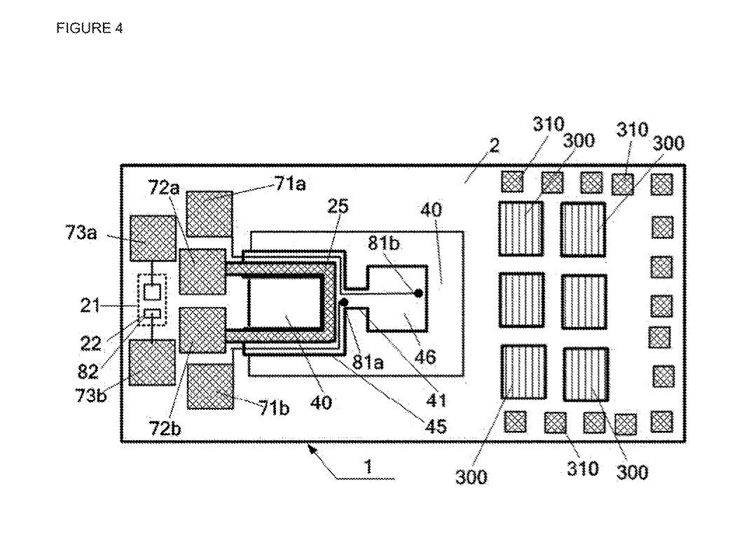

FIG. 4 is a diagrammatic plan view of a heat conduction type sensor chip 1 of the heat conduction type sensor 10 for mounting inside of the standard pressure chamber 16 in a separated type pressure gauge of the present invention, illustrating an embodiment of heat conduction type sensor chip 1 into which integrated circuits 300 are incorporated. In FIG. 4 the heat conduction type sensor chip 1 shown in FIG. 1 is illustrated, additionally including the integrated circuits 300. The circuits integrated 300 may, for example, be a heater driver circuit for driving the heat conduction type sensor, a circuit for amplifying signals from the thermo couples in the heat conduction type sensor and, where necessary, an oscillator for providing a timing rectangular waveform and/or a memory circuit. As needed, there can also be integrated a circuit for measuring an electrostatic capacitance of the region of electrostatic capacitance 20 in the Form of Implementation 1 and/or a circuit for measuring a resistance of the strain gauge 28 in the Form of Implementation 2. In such a case, wiring via terminals through the hermetic seal 12 can be utilized in order that information on an electrostatic capacitance of the region of electrostatic capacitance 20 and/or a resistance of the strain gauge 28 which are to be measured. may be exchanged with an integrated circuit or circuits 300 incorporated in the heat conduction type sensor chip 1.

### Form of Implementation 4

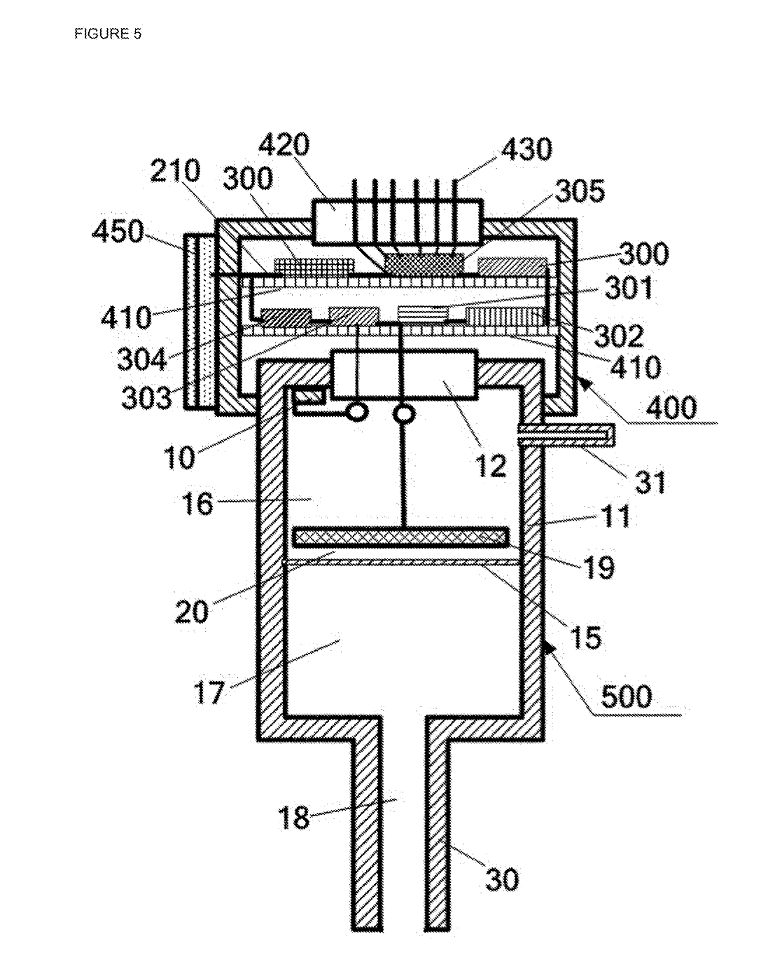

FIG. 5 is a conceptual diagrammatic view illustrating a modularized separated type pressure gauge 500 implemented on one form of the separated type pressure gauge according to the present invention. The modularized separated type pressure gauge 500 has a modular configuration that may at the least include an amplifying circuit 301 for a signal from the heat conduction type sensor chip 1 of the heat conduction type sensor 10 mounted inside of the standard pressure chamber 16, and a computing circuit 302 whereby data utilized for signals amplified by the amplifying circuit are processed in a variety of modes, and further a heater driver circuit 303 including a feedback system. Also in this form of implementation, there may be incorporated circuits for is suing signal outputs such as of barometric pressures in the measuring and standard pressure chambers 17 and 16 and further a temperature in the standard pressure chamber 16, and a display 450 for indicating them. Further, a power supply circuit such as of direct current for each of these circuits can be on board in the modularized separated type pressure gauge 500.

It should be understood that a separated type pressure gauge according to the present invention is not limited to the illustrated forms of implementation, of which various modifications may naturally be made which are identical in essentials, operation and effect to the present invention.

### INDUSTRIAL APPLICABILITY

An separated type pressure gauge according to the present invention is provided in a standard pressure chamber as in the conventional separated type pressure gauge with an ultra-small sensing part that can be formed using a MEMS technology, and it thus lends itself to mass production of a uniform shape. The sensing part being a sensitive heat conduction type sensor which may comprise a heat conduction type sensor chip 1 that is highly sensitive, it is made possible for a measured value of standard barometric pressure in the standard pressure chamber 16, if it is varied with time, to be adopted as a modified standard barometric pressure as corrected. This renders it possible to solve the prior art problem that there is no choice but to determine a barometric pressure in a measuring chamber 16 using a standard pressure preset in the standard pressure chamber at the time of its manufacture and, as the case may be, but to lead to a large error. The separated type pressure gauge provided herein is thus capable of measuring a barometric pressure, including a degree of vacuum, in the measuring chamber 17 at high precision.

1. A separated type pressure gauge having a standard pressure chamber, characterized in that it includes a heat conduction type sensor provided inside of said standard pressure chamber for measuring a barometric pressure in the standard pressure chamber, whereby the measured barometric pressure in the standard pressure chamber is utilized as a standard barometric pressure.

2. A separated type pressure gauge as set forth in claim 1 wherein the standard pressure chamber is a hermetically sealed barometric pressure chamber.

3. A separated type pressure gauge as set forth in claim 2 wherein the barometric pressure in the standard pressure chamber is made adjustable in the vicinity of a desired barometric pressure.

4. A separated type pressure gauge as set forth in claim 1 wherein the standard pressure chamber is an air pressure chamber that is open to an atmosphere.

5. A separated type pressure gauge as set forth in claim 1 wherein the heat conduction type sensor is used of a silicon substrate.

6. A separated type pressure gauge as set forth in claim 1 wherein the heat conduction type sensor has a sensing cantilever formed with at least one heater and a pair of thermo couples so that measuring a difference between outputs of said thermo couples allows a barometric pressure to be measured in said standard pressure chamber.

7. A separated type pressure gauge as set forth in claim 1 wherein the heat conduction type sensor is provided with an absolute temperature sensor.

8. A separated type pressure gauge as set forth in claim 1 wherein the heat conduction type sensor is constituted of a sensor chip incorporating an integrated circuit having an amplifier circuit.

9. A separated type pressure gauge as set forth in claim 1 wherein it is modularized having the heat conduction type sensor for a barometric sensing function and having at least an amplifier circuit, a computing circuit and a heater drive circuit which are further included therein.
